(19) United States
(12) Patent Application Publication
(10) Pub. No.: US 2025/0114866 A1
(43) Pub. Date: Apr. 10, 2025

(54) METHOD OF MANUFACTURING WELDED MEMBER

(71) Applicant: FUTABA INDUSTRIAL CO., LTD., Okazaki-shi (JP)

(72) Inventor: Shota Muto, Okazaki-shi (JP)

(21) Appl. No.: 18/822,236

(22) Filed: Sep. 1, 2024

(30) Foreign Application Priority Data
Oct. 4, 2023 (JP) 2023-173011

(51) Int. Cl. B23K 26/24; B23K 37/04; B23K 103/04

(52) U.S. Cl. CPC B23K 26/24; B23K 37/0435; B23K 2103/04

(57) ABSTRACT

Disclosed is a method of manufacturing a welded member with a metal member and a nut welded to each other. The manufacturing method includes bringing the nut into abutment with a welding surface of a plate-shaped portion of the metal member and pressing at least one of the plate-shaped portion or the nut to bring the nut into close contact with the welding surface. The manufacturing method further includes irradiating a portion of the nut in close contact with the welding surface with a beam from a side opposite to the welding surface of the plate-shaped portion to weld the metal member and the nut to each other by laser welding.

### CROSS-REFERENCE TO RELATED APPLICATIONS

This application claims the benefit of Japanese Patent Application No. 2023-173011 filed on Oct. 4, 2023 with the Japan Patent Office, the entire disclosure of which is incorporated herein by reference.

### BACKGROUND

The present disclosure relates to a method of manufacturing a welded member.

Japanese Unexamined Patent Application Publication No. 2003-053567 discloses a welding method of welding a nut having projections and a steel plate to each other by laser. In the welding method, the projections are brought into abutment with the steel plate, and then a beam is radiated to a gap formed by each of the projections between the nut and the steel plate, from the steel plate side.

### SUMMARY

However, in the above-described welding method, the steel plate and the nut are separated from each other at a position to be irradiated with the beam. Thus, in some cases, steel material melted by the beam flows toward the nut but does not reach it, and the gap may remain. In addition, in the above-described welding method, the nut may tilt during welding due to occurrence of thermal expansion or contraction in a portion irradiated with the beam, which tends to cause a weld defect between the nut and the steel plate. This has led to a problem of reduced joint strength between the nut and the steel plate.

In one aspect of the present disclosure, it is preferable to provide a technique to improve a joint strength between a nut and a metal member.

One aspect of the present disclosure is a method of manufacturing a welded member with a metal member and a nut welded to each other. The method of manufacturing the welded member comprises bringing the nut into abutment with a welding surface of a plate-shaped portion of the metal member and pressing at least one of the plate-shaped portion or the nut to bring the nut into close contact with the welding surface. The method of manufacturing the welded member further comprises irradiating a portion of the nut in close contact with the welding surface with a beam from a side opposite to the welding surface of the plate-shaped portion to weld the metal member and the nut to each other by laser welding.

In this configuration, the metal member and the nut are welded to each other by laser in a state where the nut is in close contact with the welding surface by pressing at least one of the plate-shaped portion or the nut. This reduces occurrence of a gap between the nut and the welding surface and a weld defect between the nut and the metal member, which is caused by thermal expansion or contraction of a portion irradiated with the beam. Accordingly, it is possible to improve the joint strength between the nut and the metal member.

In one aspect of the present disclosure, pressing the nut against the welding surface may bring the nut into close contact with the welding surface.

This configuration makes it possible to press the nut in its entirety, so that a large pressing force is easily applied.

In one aspect of the present disclosure, the nut may include projections. The projections may project toward the welding surface to come into abutment with the welding surface. The beam may be radiated to each of the projections.

In this configuration, the beam is radiated to each of the projections, which are portions of the nut to abut the metal member. Thus, even if a gap is formed by each of the projections between the nut and the welding surface, it is possible to improve the joint strength between the nut and the metal member.

In one aspect of the present disclosure, a beam diameter of the beam at a minimum intersection location, where an intersection plane contained in an intersection zone formed by intersection of the plate-shaped portion and a hypothetical irradiation zone of the beam has a minimum area, may be 0.9 times or more as large as a longest width of each of the projections. The longest width may be a maximum length of each of the projections along a moving direction of a zone irradiated with the beam during the laser welding.

This configuration inhibits occurrence of deep holes in welded portions formed from the melted projections, which tend to occur due to a small size of the beam diameter, and makes it possible to melt the projections appropriately.

In one aspect of the present disclosure, the metal member may be formed of super high tensile strength material.

This configuration makes it easier to stabilize the joint strength between the super high tensile strength material and the nut.

### BRIEF DESCRIPTION OF THE DRAWINGS

Example embodiments of the present disclosure will be described hereinafter by way of example with reference to the accompanying drawings, in which:

FIG. 1 is a schematic diagram showing a welded member;

FIG. 2 is a schematic bottom view showing a nut;

FIG. 3 is a schematic diagram showing a method of manufacturing the welded member;

FIG. 4 is a schematic plan view showing a state in which the nut is held by nut holders;

FIG. 5 is a diagram showing minimum intersection locations of a beam when the beam is radiated in focus or out of focus to an irradiation target; and

FIG. 6 is a diagram showing a beam diameter.

### DETAILED DESCRIPTION OF EXEMPLARY EMBODIMENTS

### 1. Configuration

### Welded Member

The welded member 100 in FIG. 1 is a member with a metal member 1 and a nut 2 welded to each other by laser.

The metal member 1 is, for example, a thin plate-shaped member with a plate thickness of 3.0 mm or less. Alternatively, it is preferable that a plate thickness of the metal member be 1.6 mm or less, and more preferable that it be 1.0 mm. The metal member 1 is formed of a super high tensile strength steel with a tensile strength of 1180 MPa or more, that is, a super high tensile strength material. Alternatively, it is more preferable that a tensile strength of the metal member be 1470 MPa or more. The metal member 1 includes a welding surface 11, to which a nut 2 is welded, and a non-welding surface 12, which is on an opposite side of the welding surface 11. The metal member 1 further includes at least one hole 13 penetrating the metal member 1 in its thickness directions, which are directions in which the welding surface 11 and the non-welding surface 12 are aligned.

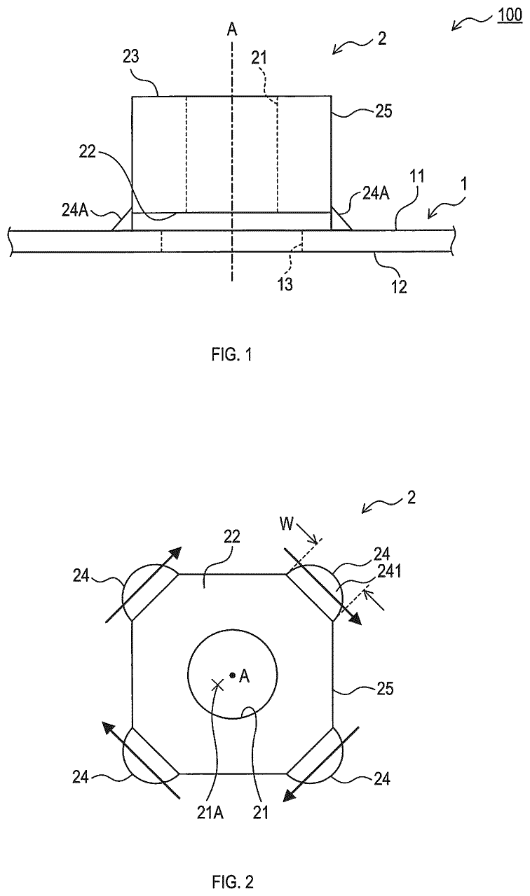

The nut 2 is, for example, a quadrilateral welding nut formed of iron or other metals for use in projection welding. Alternatively, an outer shape of the nut in a plane view may be a circle or a polygon other than a quadrilateral, and the nut may have a flange. Further, the nut may have a shape designed for laser welding. As shown in FIGS. 1 and 2, the nut 2 includes a screw hole 21, a first end face 22, a second end face 23, four projections 24, and side faces 25.

The screw hole 21 is arranged to penetrate the nut 2. A bolt or the like is inserted into the screw hole 21 to be fastened.

The first end face 22 surrounds an opening at one end of the screw hole 21, and the second end face 23 surrounds an opening at the other end of the screw hole 21. The side faces 25 connect the first end face 22 and the second end face 23 to each other. In the present embodiment, the side faces 25 are composed of four faces, and two of them, which are adjacent to each other, are orthogonal to each other.

The projections 24 are portions that are melted by laser welding and project relative to the first end face 22. The projections 24 project toward the welding surface 11 side of the metal member 1 to come into abutment with the welding surface 11. In the present embodiment, each of the projections 24 extends from the side faces 25 and the first end face 22 so as to cover a corner located at a position where the side faces 25 and the first end face 22 intersect. Alternatively, the projections may extend only from the side faces or project only from the first end face. In the present embodiment, the four projections 24 are provided so as to surround the opening 21A at approximately regular intervals. Specifically, each of the projections 24 is positioned at a corresponding corner of the nut 2. Alternatively, the number of the projections may be three, or five or more, for example.

Each of the projections 24 includes a leading-end face 241 to abut the welding surface 11. As shown in FIG. 2, the leading-end face 241 has a semicircular outer shape, and a straight part of an outline of the leading-end face 241 fronts toward a central axis A that passes through a center of the screw hole 21 of the nut 2. Alternatively, the projections may have various shapes. In the following description, portions where the metal member 1 and the nut 2 are welded to each other, formed by melting the metal member 1 and the projections 24 by laser welding, are referred to as welded portions 24A.

### Laser Welding Apparatus

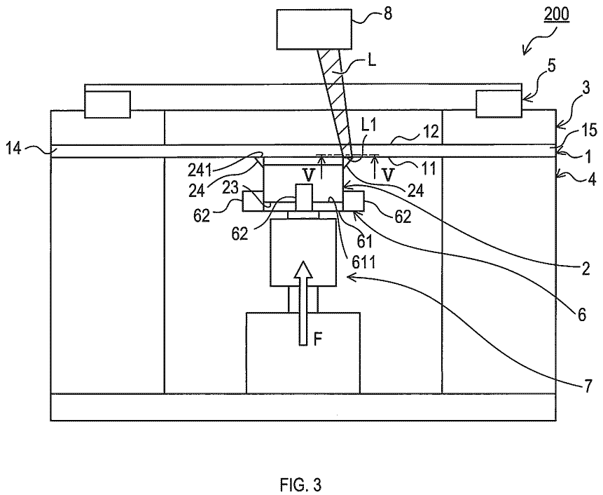

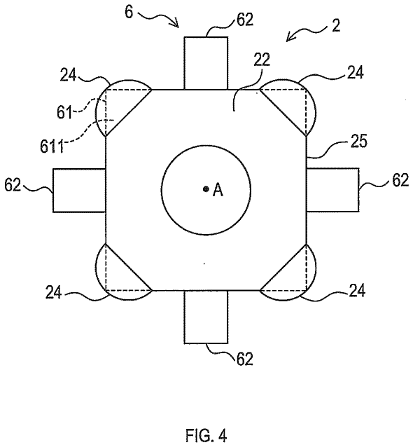

Next, with reference to FIGS. 3 and 4, a laser welding apparatus 200 will be explained in detail. FIG. 3 shows a state in which the laser welding apparatus 200 is welding the metal member 1 and the nut 2 by laser. FIG. 4 shows a state in which the nut 2 is held by a later-described nut holder 6. The laser welding apparatus 200 includes a member-fixing clamp 3, a clamp support 4, a clamper 5, the nut holder 6, a pressurization cylinder 7, and a laser radiation device 8.

The member-fixing clamp 3 and the clamp support 4 are jigs that are arranged to face each other in up-down directions, and allow the metal member 1 to be placed and held between them. The clamp support 4 is positioned below the member-fixing clamp 3. In the present embodiment, the clamp support 4 is formed to create an internal space for placing the nut 2 to be welded to the metal member 1. The member-fixing clamp 3 is formed to create a space above the above-described internal space to irradiate the metal member 1 with a beam L from the later-described laser radiation device 8. For example, as shown in FIG. 3, the member-fixing clamp 3 and the clamp support 4 hold a first end portion 14 and a second end portion 15 of the metal member 1 between them.

The clamper 5 is a fixture to fix the member-fixing clamp 3 and the clamp support 4. The clamper 5 is positioned above the member-fixing clamp 3. The clamper 5 is arranged so as not to obstruct the beam L radiated by the later-described laser radiation device 8. Alternatively, the clamper may have a function to push the member-fixing clamp downwards to press the metal member 1 against the nut 2.

The nut holder 6 is a jig to hold the nut 2. The nut holder 6 holds the nut 2 with the projections 24 of the nut 2 facing up. The nut holder 6 includes a base 61 and four holding catches 62.

The base 61 is a plate-shaped member with a quadrangular outer shape in a plane view on which the nut 2 is to be placed. The base 61 has a contact surface 611 to abut the second end face 23 of the nut 2.

The holding catches 62 are portions that protrude relative to the contact surface 611 of the base 61 and are to be in abutment with the side faces 25 of the nut 2. In the present embodiment, as shown in FIG. 3, each of the holding catches 62 extends from a corresponding end face of the base 61. Alternatively, the holding catches may protrude from a part of the contact surface of the base that is not to be in abutment with the nut 2. In the present embodiment, as shown in FIG. 4, the four holding catches 62 are provided to surround the base 61 at approximately regular intervals. Specifically, each of the holding catches 62 is positioned at a corresponding substantial center of four faces that form the end faces of the base 61. Alternatively, the number of the holding catches may be, for example, two or three. As mentioned above, the four projections 24 of the nut 2 are positioned at four corners of the nut 2, respectively. Thus, in a state where the nut 2 is placed on the base 61, each of the projections 24 of the nut 2 is located between two of the holding catches 62 which are adjacent to each other.

This makes it easy to position the nut 2 relative to the nut holder 6 in the laser welding apparatus 200. In addition, the four holding catches 62 can inhibit the nut 2 from rotating about the central axis A of the nut 2.

The pressurization cylinder 7 is a device to press the nut 2 against the welding surface 11 of the metal member 1. The pressurization cylinder 7 is arranged inside the above-described internal space formed by the clamp support 4 and positioned below the nut holder 6. The pressurization cylinder 7 pushes the nut holder 6 up to press the nut 2 against the welding surface 11.

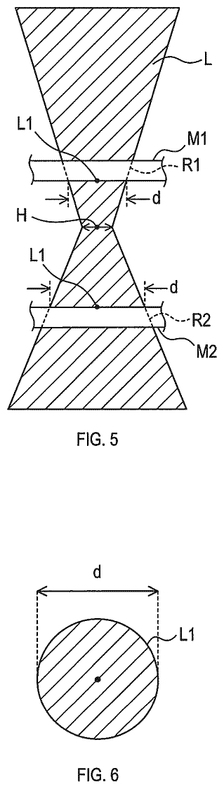

The laser radiation device 8 is a device positioned above the clamper 5 and configured to radiate the beam L in a downward direction. The laser radiation device 8 is configured such that a size of a beam diameter of the beam L is changeable by defocusing. In the present embodiment, the beam L is radiated in focus to an irradiation target. As illustrated with the irradiation target M1 in FIG. 5, in focus means that a focal point H of the beam L is focused behind the irradiation target M1. Meanwhile, the beam L may be radiated out of focus to the irradiation target. As illustrated with the irradiation target M2 in FIG. 5, out of focus means that the focal point H of the beam L is focused in front of the irradiation target M2. However, in the in-focus case, a diameter of an irradiation zone of the beam L is reduced along a direction in which the beam L is radiated, so that it is easier to concentrate a heat of the beam L onto the irradiation target M1 compared to the out-of-focus case. As shown in FIGS. 5 and 6, a beam diameter d refers to the diameter of the irradiation zone of the beam L at a minimum intersection location L1, where an intersection plane contained in either an intersection zone R1 or an intersection zone R2 formed by intersection of either the irradiation target M1 or the irradiation target M2 and a hypothetical irradiation zone of the beam L has a minimum area. The hypothetical irradiation zone of the beam L is the irradiation zone of the beam L when the irradiation target M1, M2 does not exist. The intersection plane is a plane that is located at any part in thickness directions of the irradiation target M1, M2 and that extends substantially perpendicular to the thickness directions thereof. Alternatively, to make a size of the beam diameter of the beam changeable, the laser radiation device may include a changing member that changes a path of light, such as Diffractive Optical Element (DOE).

### Method of Manufacturing Welded Member Using Laser Welding Apparatus

A description will be given of a method of manufacturing the welded member 100 using the laser welding apparatus 200 with reference to FIGS. 2 and 3.

First, the nut 2 is brought into abutment with the welding surface 11 of the metal member 1. More specifically, the nut 2, with the projections 24 facing up, is arranged on the nut holder 6 which is to be placed on the pressurization cylinder 7. Then, the metal member 1 is arranged on the nut 2 so that the screw hole 21 of the nut 2 and the hole 13 of the metal member 1 are aligned with each other and that the projections 24 and the metal member 1 come into abutment with each other. Then, the metal member 1 arranged on the nut 2 is fixed by the member-fixing clamp 3, the clamp support 4, and the clamper 5.

Next, the nut 2 is pressed against the metal member 1 by the pressurization cylinder 7, specifically in an upward direction. This brings the leading-end faces 241 of the projections 24 of the nut 2 into close contact with the welding surface 11 of the metal member 1. As mentioned above, the metal member 1 is fixed by the member-fixing clamp 3, the clamp support 4, and the clamper 5, which inhibits the metal member 1 from rising even if a force F exerted by the pressurization cylinder 7 to press the nut 2 is applied to the metal member 1.

Next, the laser radiation device 8 irradiates a portion of the nut 2 in close contact with the welding surface 11 with the beam L from the non-welding surface 12 side of the metal member 1, and welds the metal member 1 and the nut 2 to each other by laser. In the present embodiment, the beam L is radiated to the projections 24 of the nut 2 from the non-welding surface 12 side. More specifically, the beam L hits on the non-welding surface 12 of the metal member 1 and then the heat from the beam L first melts the metal member 1. After that, the heat from the beam L continues to melt, thus melting the projections 24. Then, by cooling melted portions of the metal member 1 and the projections 24, four welded portions 24A are formed.

In the present embodiment, one projection 24 is selected out of the four projections 24 and the beam L is radiated to the selected one projection 24 first. After that, other projections 24 are selected in turn in a clockwise direction, and the beam L is radiated to each of the other projections 24 in turn. As a result of this, four welded portions 24A are formed in the present embodiment.

The irradiation zone of the beam L moves in straight lines along welding directions indicated by arrows in FIG. 2, so that the beam L forms the welded portions 24A. In one example shown in FIG. 2, the welding directions are along the first end face 22 of the nut 2 and in parallel to the straight parts of the outlines of the leading-end faces 241 of the projections 24. In the following description, a maximum length of each of the projections 24 of the nut 2 along its corresponding welding direction is referred to as a longest width W of each of the projections 24. In one example shown in FIG. 2, the longest width W is a diameter of a semicircle formed by the outline of the leading-end face 241 of each of the projections 24. For example, the longest width W of each of the projections 24 is approximately 2 mm.

In the present embodiment, the beam L is radiated in focus to the metal member 1, which is the irradiation target of the beam L. Thus, as shown in FIG. 3, the minimum intersection location L1 of the beam L is a location on the welding surface 11 of the metal member 1 where the projections 24 are in close contact. Alternatively, the minimum intersection location of the beam is not limited to the location on the welding surface 11 where the projections 24 are in close contact, and may be at any location in the metal member 1 along the thickness directions thereof. For example, when the beam is radiated out of focus to the metal member 1, the minimum intersection location of the beam may be on the non-welding surface 12 of the metal member 1. The beam diameter d of the beam L is set to 0.3 mm or more. In the present embodiment, the beam diameter d is 0.9 times or more as large as the longest width W of each of the projections 24. Note that preferably the beam diameter d is substantially equal to the longest width W of each of the projections 24. Specifically, when the longest width W of each of the projections 24 is approximately 2 mm, the beam diameter d is set to approximately 1.8 mm, where the longest width W and the beam diameter d substantially coincide with each other.

### 2. Effects

According to the embodiment detailed above, the following effects can be obtained.

(2a) In the present embodiment, the nut 2 has the four projections 24, and the beam L is radiated to each of the projections 24, which is a portion of the nut 2 in abutment with the welding surface 11 of the metal member 1. Thus, in the configuration of the present embodiment, weld defects are less likely to occur compared to a case where the beam L is radiated to a gap between the nut 2 and the welding surface 11. As a result, it is possible to improve a joint strength between the nut 2 and the metal member 1.

(2b) In the present embodiment, the nut 2 is pressed against the metal member 1 by the pressurization cylinder 7. As a result of this, in a state where the projections 24 of the nut 2 are in close contact with the welding surface 11 of the metal member 1, the beam L is radiated to each of the projections 24 to form the welded portions 24A. Thus, a gap is less likely to occur between each of the welded portions 24A and the welding surface 11. Further, even if thermal expansion or contraction of a portion irradiated with the beam L produces a force acting in a direction that causes the nut 2 to tilt during laser welding, the above-described pressure inhibits such tilting, so that weld defects between the nut 2 and the metal member 1 are less likely to occur. Accordingly, it is possible to further improve the joint strength between the nut 2 and the metal member 1.

(2c) In the present embodiment, the beam L is radiated to the nut 2 from the non-welding surface 12 side of the metal member 1. Here, when pushing the metal member 1 to press the nut 2 against the welding surface 11, for example, it is necessary to press a portion of the metal member 1 where the nut 2 is not located, such as the first end portion 14 and the second end portion 15 of the metal member 1, so as not to obstruct the beam L. In this case, if a pressing force applied to the metal member 1 is increased, a defect such as a bend in the metal member 1 may occur. On the other hand, as in the present embodiment, when pushing the nut 2 with the pressurization cylinder 7 to press the nut 2 against the welding surface 11, it is possible to press the nut 2 in its entirety without obstructing the beam L. This makes it easier to apply a large pressing force to the nut 2. As a result, it is easier to improve a degree of close contact between the projections 24 of the nut 2 and the welding surface 11.

(2d) In the present embodiment, the beam diameter d is substantially equal to the longest width W of each of the projections 24. This inhibits occurrence of a hole that is likely to occur during laser welding due to a small size of the beam diameter, such as a deep hole in each of the welded portions 24A or a through-hole penetrating each of the welded portions 24A. If the hole occurs in the welded portions, welding strength tends to be reduced. Thus, in the present embodiment, it is possible to melt the projections 24 appropriately, while inhibiting reduction in the joint strength caused by each of the welded portions 24A.

(2e) When projection welding, for example, is used to weld the nut to the metal member formed of the super high tensile strength material with a thin plate thickness, a distance becomes smaller between the projections and an electrode used for projection welding. Thus, a heat applied to the projections easily escapes and a stress caused by thermal contraction or the like tends to be concentrated in the welded portions, so that the joint strength between the nut and the metal member tends to be unstable. On the other hand, as in the present embodiment, when laser welding is used to weld the nut 2 to the metal member 1 formed of the super high tensile strength material with the thin plate thickness, the heat applied to the projections 24 is less likely to escape and the stress caused by thermal contraction or the like tends not to be concentrated in the welded portions 24A. Thus, the joint strength between the nut 2 and the metal member 1 is easily stabilized. In addition, an average push-in peel strength of the nut 2 relative to the metal member 1 tends to be higher. As a result, it is possible to improve a quality of the welding member 100.

### 3. Other Embodiments

The embodiment of the present disclosure has been described so far. However, needless to say, the present disclosure is not limited to the above-described embodiment and may take various forms.

(3a) In the above-described embodiment, the metal member 1 is a plate-shaped member. However, the shape of the metal member is not limited to this. For example, the metal member may be in various shapes with a plate-shaped portion having a thin plate thickness. In a configuration where the metal member has the plate-shaped portion, the nut 2 is welded to the welding surface of the plate-shaped portion.

(3b) In the above-described embodiment, pressing the nut 2 against the metal member 1 brings the projections 24 of the nut 2 into close contact with the welding surface 11 of the metal member 1. However, a method of making the projections in close contact with the welding surface is not limited to this. For example, the laser welding apparatus may include a device pressing the metal member 1 against the nut 2, and both the nut 2 and the metal member 1 may be pressed in such directions that the nut 2 and the metal member 1 come into close contact with each other. In addition, for example, with a position of the nut 2 fixed, only the metal member 1 may be pressed against the nut 2.

(3c) In the above-described embodiment, the nut 2 has projections 24. However, the nut does not need to have projections. In a configuration where the nut has no projection, the beam L is radiated to a specific location to be welded among portions of the nut in close contact with the welding surface.

(3d) In the above-described embodiment, the beam diameter d is substantially the same as the longest width W of each of the projections 24. However, a size of the beam diameter is not limited to this. For example, the beam diameter may be shorter than the longest width W. Specifically, when the longest width W is approximately 2 mm, the beam diameter may be shorter than the longest width W and 0.3 mm or more, for example. Or, the beam diameter may be longer than the longest width W, for example.

(3e) The above-described embodiment shows a configuration in which the metal member 1 is formed of super high tensile strength material. However, a metal type of the metal member is not limited to this. The metal member may be formed of other metal.

(3f) In the above-described embodiment, the four projections 24 are welded in turn in the clockwise direction, one after another. However, for example, the projections may be welded in turn in a counterclockwise direction, one after another. In addition, for example, after welding a selected projection, another projection diagonally opposite the selected projection may be selected and welded. In addition, for example, projections may be welded at the same time by splitting one beam into beams or using a plurality of beam sources that radiate beams.

(3g) In the above-described embodiment, the nut holder 6 includes holding catches 62. However, for example, if the laser welding apparatus includes a camera, sensor, or the like and is configured to recognize a position of each of the projections 24 with the camera, sensor, or the like, the nut holder does not need to have holding catches. When the nut 2 is placed on the nut holder without holding catches, the projections 24 are easily displaced. However, when the laser welding apparatus has the above-described configuration, it is possible to modify a position where the beam is radiated and radiate the beam to each of the projections 24 even if the projections 24 are displaced.

(3h) In the above-described embodiment, the irradiation zone of the beam L moves in straight lines. However, the irradiation zone of the beam L may move to draw a curved line or a circle, for example.

(3i) A bolt or the like may be inserted into the screw hole 21 of the nut 2 during laser welding to inhibit a spatter from sticking to the non-welding surface 12 of the nut 2. In addition, the laser welding apparatus may be provided with an air transmitter so that the air inhibits the spatter from sticking to the non-welding surface 12 of the nut 2.

(3j) A function performed by a single element in the above-described embodiments may be achieved by a plurality of elements, or functions performed by a plurality of elements may be achieved by a single element. Also, a part of a configuration in the above-described embodiments may be omitted. Moreover, at least a part of a configuration in the above-described embodiments may be added to, or may replace, another configuration in the above-described embodiments.

### 4. Technical Idea Disclosed Herein

### [Item 1]

A method of manufacturing a welded member with a metal member and a nut welded to each other, the method comprising:
bringing the nut into abutment with a welding surface of a plate-shaped portion of the metal member and pressing at least one of the plate-shaped portion or the nut to bring the nut into close contact with the welding surface, and
irradiating a portion of the nut in close contact with the welding surface with a beam from a side opposite to the welding surface of the plate-shaped portion to weld the metal member and the nut to each other by laser welding.

### [Item 2]

The method of manufacturing a welded member according to item 1,
wherein pressing the nut against the welding surface brings the nut into close contact with the welding surface.

### [Item 3]

The method of manufacturing a welded member according to item 1 or 2,
wherein the nut includes projections that project toward the welding surface to come into abutment with the welding surface, and
wherein the beam is radiated to each of the projections.

### [Item 4]

The method of manufacturing a welded member according to item 3,
wherein a beam diameter of the beam at a minimum intersection location, where an intersection plane contained in an intersection zone formed by intersection of the plate-shaped portion and a hypothetical irradiation zone of the beam has a minimum area, is 0.9 times or more as large as a longest width of each of the projections, and
wherein the longest width is a maximum length of each of the projections along a moving direction of a zone irradiated with the beam during the laser welding.

### [Item 5]

The method of manufacturing a welded member according to any one of items 1 through 4,
wherein the metal member is formed of super high tensile strength material.

What is claimed is:

1. A method of manufacturing a welded member with a metal member and a nut welded to each other, the method comprising:
bringing the nut into abutment with a welding surface of a plate-shaped portion of the metal member and pressing at least one of the plate-shaped portion or the nut to bring the nut into close contact with the welding surface, and
irradiating a portion of the nut in close contact with the welding surface with a beam from a side opposite to the welding surface of the plate-shaped portion to weld the metal member and the nut to each other by laser welding.

2. The method of manufacturing a welded member according to claim 1,
wherein pressing the nut against the welding surface brings the nut into close contact with the welding surface.

3. The method of manufacturing a welded member according to claim 1,
wherein the nut includes projections that project toward the welding surface to come into abutment with the welding surface, and
wherein the beam is radiated to each of the projections.

4. The method of manufacturing a welded member according to claim 3,
wherein a beam diameter of the beam at a minimum intersection location, where an intersection plane contained in an intersection zone formed by intersection of the plate-shaped portion and a hypothetical irradiation zone of the beam has a minimum area, is 0.9 times or more as large as a longest width of each of the projections, and
wherein the longest width is a maximum length of each of the projections along a moving direction of a zone irradiated with the beam during the laser welding.

5. The method of manufacturing a welded member according to claim 1,
wherein the metal member is formed of super high tensile strength material.
